(19) United States
(12) Patent Application Publication
(10) Pub. No.: US 2024/0428380 A1
(43) Pub. Date: Dec. 26, 2024

(54) PERSONALIZED IMAGE OR VIDEO ENHANCEMENT

(71) Applicant: Microsoft Technology Licensing, LLC, Redmond, WA (US)

(72) Inventor: Ross G. CUTLER, Clyde Hill, WA (US)

(73) Assignee: Microsoft Technology Licensing, LLC, Redmond, WA (US)

(21) Appl. No.: 18/211,740

(22) Filed: Jun. 20, 2023

(51) Int. Cl. G06T 5/00; G06T 7/194; G06V 40/16; G06V 40/50; G06V 40/60

(52) U.S. Cl. CPC G06T 5/70; G06T 7/194; G06V 40/172; G06V 40/50; G06V 40/67; G06T 2207/10016; G06T 2207/20081; G06T 2207/20132; G06T 2207/30201

(57) ABSTRACT

This document relates to personalized image or video processing. For example, the disclosed implementations can identify a designated user of a computing device that participates in a video call with other users. When another person appears in a video feed captured by the computing device, the other person can be removed. This can avoid distractions that can be caused, for example, by family members or pets that inadvertently walk into the field of view while a designated user is participating in a video call. Similar techniques can be employed to remove people other than designated users from still images.

### BACKGROUND

One important use case for computing devices involves teleconferencing, where participants communicate with remote users via audio and/or video over a network. Often, audio or video signals for a given teleconference can include impairments that can be mitigated by enhancing the signals with an enhancement model, e.g., by removing noise or echoes from an audio signal or correcting low-lighting conditions in a video signal. However, while existing enhancement models can significantly improve audio and video quality, there remain further opportunities to improve user satisfaction in teleconferencing scenarios.

### SUMMARY

This Summary is provided to introduce a selection of concepts in a simplified form. These comments are further described below in the Detailed Description. This Summary is not intended to identify key features or essential features of the claimed subject matter, nor is it intended to be used to limit the scope of the claimed subject matter.

The description generally relates to techniques for distributed teleconferencing. One example includes a method or technique that can be performed on a computing device. The method or technique can include obtaining a video signal captured by a first device participating in a video call with a second device. The first device can have a designated user. The method or technique can also include determining that a person other than the designated user appears in the video signal, and enhancing the video signal by at least partially removing the person other than the designated user from the video signal to obtain an enhanced video signal. The method or technique can also include sending the enhanced video signal to the second device.

Another example includes a system having a hardware processing unit and a storage resource storing computer-readable instructions. When executed by the hardware processing unit, the computer-readable instructions can cause the system to obtain a video signal captured by a first device participating in a video call with a second device. The first device can have a designated user. The computer-readable instructions can also cause the system to detect that a person other than the designated user appears in the video signal and enhance the video signal to obtain an enhanced video signal by at least partially removing the person other than the designated user from the video signal. The computer-readable instructions can also cause the system to send the enhanced video signal to the second device.

Another example includes a computer-readable storage medium storing executable instructions. When executed by a processor, the executable instructions can cause a processor to perform acts. The acts can include obtaining an image captured by a first device. The first device can have a designated user. The acts can also include, responsive to a person other than the designated user appearing in the image, enhancing the image to obtain an enhanced image by at least partially removing the person other than the designated user. The acts can also include sending the enhanced image to the first device, to the second device or storing the enhanced image in an image repository.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example system, consistent with some implementations of the present concepts.

FIG. 2A-2C illustrate an example personalized video enhancement scenario with a single enrolled user, consistent with some implementations of the present concepts.

FIG. 3A-3C illustrate an example personalized video enhancement scenario with multiple enrolled users, consistent with some implementations of the present concepts.

FIG. 4A-4C illustrate an example scenario for a user to opt-in to personalized audio and video enhancement, consistent with some implementations of the present concepts.

FIG. 5 illustrates an example of enrollment processing for personalized video enhancement, consistent with some implementations of the present concepts.

FIG. 6 illustrates an example personalized video enhancement workflow, consistent with some implementations of the present concepts.

FIG. 7 illustrates an example method or technique for personalized video enhancement, consistent with some implementations of the disclosed techniques.

FIG. 8 illustrates an example graphical user interface for user feedback regarding personalized video enhancement, consistent with some implementations of the disclosed techniques.

### DETAILED DESCRIPTION

### Overview

The disclosed implementations generally offer techniques for enabling high-quality user experience for teleconferences. As noted previously, conventional teleconferencing solutions often employ audio enhancement models to remove unwanted impairments such as echoes and/or noise from audio signals during a call. For instance, personalized audio enhancement models can filter an audio signal by attenuating sounds other than the voice of a particular user. Thus, for instance, sounds such as background noise or the voices of other users can be removed from the audio signal.

The use of personalized audio enhancement can greatly improve teleconferencing quality by reducing noise and echoes and making it easier for other users to understand speech by a given user. However, current video enhancement models are generally not personalized for a particular user. For instance, if a video shows two users speaking at the same time, a personalized audio enhancement model can remove the speech of one of the users, but the video will still show both users speaking. This can create a confusing and inconsistent experience, because other call participants can see both user speaking but only hear the voice of one of the users.

The disclosed implementations can overcome these deficiencies of prior techniques by employing personalized video enhancement. A video signal for a teleconference can be processed to remove users other than a designated user from the video signal. This approach can create a higher-quality teleconferencing experience for several reasons, e.g., unwanted users are removed from the video signal and there is consistency between the video and audio signals if a personalized audio enhancement model is employed that removes the voices of the unwanted users. As also discussed more below, the disclosed techniques can be employed to remove unwanted users from still images.

### Definitions

For the purposes of this document, the term “signal” refers to a function that varies over time or space. A signal can be represented digitally using data samples, such as audio samples, video samples, or one or more pixels of an image. An “enhancement model” refers to a model that processes data samples from an input signal to enhance the perceived quality of the signal. For instance, an enhancement model could remove noise or echoes from audio data, or could sharpen image or video data. The term “personalized enhancement model” refers to an enhancement model that has been adapted to enhance a signal specifically for a given user. For instance, as discussed more below, a personalized audio enhancement model could be adapted to filter out noise, echoes, etc., to isolate a particular user's voice by attenuating components of an audio signal produced by other sound sources. A personalized video enhancement model could be adapted to remove, from a video signal, people other than one or more designated users of a device. A personalized image enhancement model could be adapted to remove, from a still image, people other than one or more designated users. In the case of still images, the designated users could include an owner of an image repository and family/friends or other people designated by the owner.

The term “mixing,” as used herein, refers to combining two or more signals to produce another signal. Mixing can include adding two audio signals together, interleaving individual audio signals in different time slices, synchronizing audio signals to video signals, etc. In some cases, audio signals from two co-located devices can be mixed to obtain a playback signal. The term “synchronizing” means aligning two or more signals, e.g., prior to mixing. For instance, two or more microphone signals can be synchronized by identifying corresponding frames in the respective signals and temporally aligning those frames. Likewise, loudspeakers can also be synchronized by identifying and temporally aligning corresponding frames in sounds played back by the loudspeakers.

The term “co-located,” as used herein, means that two devices have been determined to be within proximity to one another according to some criteria, e.g., the devices are within the same room, within a threshold distance of one another, etc. The term “playback signal,” as used herein, refers to a signal that is played back by a loudspeaker. A playback signal can be a combination of one or more microphone signals. An “enhanced” signal is a signal that has been processed using an enhancement model to improve some signal characteristic of the signal.

The term “signal characteristic” describes how a signal can be perceived by a user, e.g., the overall quality of the signal or a specific aspect of the signal such as how noisy an audio signal is, how blurry an image signal is, etc. The term “quality estimation model” refers to a model that evaluates an input signal to estimate how a human might rate the perceived quality of the input signal for one or more signal characteristics. For example, a first quality estimation model could estimate the speech quality of an audio signal and a second quality estimation model could estimate the overall quality and/or background noise of the same audio signal. Audio quality estimation models can be used to estimate signal characteristics of an unprocessed or raw audio signal or a processed audio signal that has been output by a particular data enhancement model. The output of a quality estimation model can be a synthetic label representing the signal quality of a particular signal characteristic. Here, the term “synthetic label” means a label generated by a machine evaluation of a signal, where a “manual” label is provided by human evaluation of a signal.

The term “model” is used generally herein to refer to a range of processing techniques, and includes models trained using machine learning as well as hand-coded (e.g., heuristic-based) models. For instance, a machine-learning model could be a neural network, a support vector machine, a decision tree, etc. Whether machine-trained or not, data enhancement models can be configured to enhance or otherwise manipulate signals to produce processed signals. Data enhancement models can include codecs or other compression mechanisms, audio noise suppressors, echo removers, distortion removers, image/video healers, low light enhancers, image/video sharpeners, image/video denoisers, etc., as discussed more below.

The term “impairment,” as used herein, refers to any characteristic of a signal that reduces the perceived quality of that signal. Thus, for instance, an impairment can include noise or echoes that occur when recording an audio signal, or blur or low-light conditions for images or video. One type of impairment is an artifact, which can be introduced by a data enhancement model when removing impairments from a given signal. Viewed from one perspective, an artifact can be an impairment that is introduced by processing an input signal to remove other impairments. Another type of impairment is a recording device impairment introduced into a raw input signal by a recording device such as a microphone or camera. Another type of impairment is a capture condition impairment introduced by conditions under which a raw input signal is captured, e.g., room reverberation for audio, low light conditions for image/video, etc.

The following discussion also mentions audio devices such as microphones and loudspeakers. Note that a microphone that provides a microphone signal to a computing device can be an integrated component of that device (e.g., included in a device housing) or can be an external microphone in wired or wireless communication with that computing device. Similarly, when a computing device plays back a signal over a loudspeaker, that loudspeaker can be an integrated component of the computing device or in wired or wireless communication with the computing device. In the case of a wired or wireless headset, a microphone and one or more loudspeakers can be integrated into a single peripheral device that sends microphone signals to a corresponding computing device and outputs a playback signal received from the computing device.

### Machine Learning Overview

There are various types of machine learning frameworks that can be trained to perform a given task, such as estimating the quality of a signal, enhancing a signal, detecting faces or bodies of users in a video or still image, performing facial recognition of detected faces, segmenting video or still images into foreground objects and background, and/or partially or fully removing objects from a video signal or still image. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “internal parameters” is used herein to refer to learnable values such as edge weights and bias values that can be learned by training a machine learning model, such as a neural network. The term “hyperparameters” is used herein to refer to characteristics of model training, such as learning rate, batch size, number of training epochs, number of hidden layers, activation functions, etc.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with internal parameters for the model structure that have been trained or tuned. Note that two trained models can share the same model structure and yet have different values for the internal parameters, e.g., if the two models are trained on different training data or if there are underlying stochastic processes in the training process.

### Example System

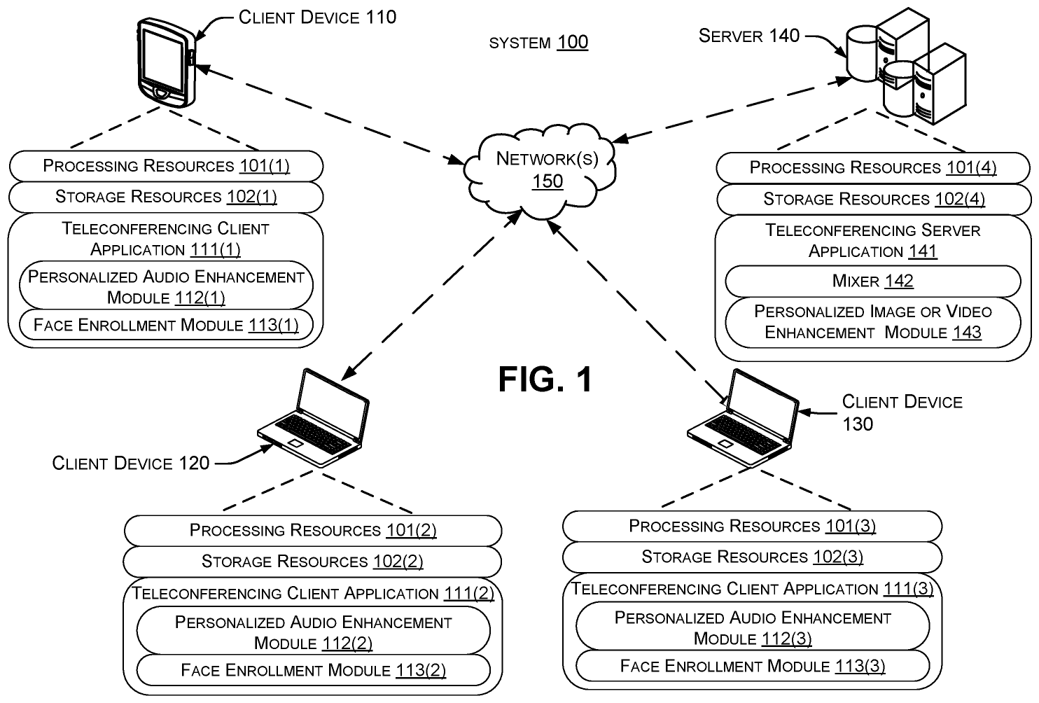

The present implementations can be performed in various scenarios on various devices. FIG. 1 shows an example system 100 in which the present implementations can be employed, as discussed more below.

As shown in FIG. 1, system 100 includes a client device 110, a client device 120, a client device 130, and a server 140, connected by one or more network(s) 150. Note that the client devices can be embodied as mobile devices such as smart phones, laptops, or tablets, as well as stationary devices such as desktops, server devices, etc. Likewise, the servers can be implemented using various types of computing devices. In some cases, any of the devices shown in FIG. 1, but particularly the servers, can be implemented in data centers, server farms, etc.

Certain components of the devices shown in FIG. 1 may be referred to herein by parenthetical reference numbers. For the purposes of the following description, the parenthetical (1) indicates an occurrence of a given component on client device 110, (2) indicates an occurrence of a given component on client device 120, (3) indicates an occurrence of a given component on client device 130, and (4) indicates an occurrence of a given component on server 140. Unless identifying a specific instance of a given component, this document will refer generally to the components without the parenthetical.

Generally, the devices 110, 120, 130, and 140 may have respective processing resources 101 and storage resources 102, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client devices 110, 120, and/or 130 can include respective instances of a teleconferencing client application 111. The teleconferencing client application can provide functionality for allowing users of the client devices to conduct teleconferencing with one another. Each instance of the teleconferencing client application can include a corresponding personalized audio enhancement module 112 configured to perform personalized microphone signal enhancement for a user of that client device. Thus, personalized audio enhancement model 112(1) can enhance microphone signals in a manner that is personalized to a first user of client device 110 when the first user is conducting a call using teleconferencing client application 111(1). Likewise, personalized audio enhancement model 112(2) can enhance microphone signals in a manner that is personalized to a second user of client device 120 when the second user is conducting a call using teleconferencing client application 111(2). Similarly, personalized audio enhancement model 112(3) can enhance microphone signals in a manner that is personalized to a third user of client device 130 when the third user is conducting a call using teleconferencing client application 111(3). U.S. patent application Ser. No. 17/848,674, filed Jun. 24, 2022 (Attorney Docket No. 411559-US-NP), describes approaches for personalized audio enhancement, and is incorporated herein by reference in its entirety. Additional approaches for personalized audio enhancement are discussed in Eskimez, et al., (2022 May), Personalized speech enhancement: New models and comprehensive evaluation, in ICASSP 2022-2022 IEEE International Conference on Acoustics, Speech and Signal Processing (ICASSP) (pp. 356-360), IEEE.

Face enrollment module 113 can be configured to capture enrollment information for one or more users of each respective client device. As discussed more below, the enrollment information can facilitate removing non-enrolled users from video signals or still images. For instance, the face enrollment module can capture images of a user of a device during automatic or explicit enrollment, discussed more below. The captured images can be used to derive a face representation of the user's face, as also discussed more below.

Teleconferencing server application 141 on server 140 can coordinate calls among the individual client devices by communicating with the respective instances of the teleconferencing client application 111 over network(s) 150. For instance, teleconferencing server application 141 can also have a mixer 142 that selects, synchronizes, and/or mixes individual microphone signals from the respective client devices to obtain one or more playback signals, and communicates the playback signals to one or more remote client devices during a call. The mixer can also mix video signals together with the audio signals and communicate the mixed video/audio signals to participants in a call. Personalized image or video enhancement module 143 can remove non-enrolled users from video streams received from each client device to obtain enhanced video streams that are provided to the mixer for communication to other devices. The personalized image or video enhancement model can also remove non-enrolled users from still images, e.g., in an image repository of a particular user.

For instance, the personalized image or video enhancement module 143 can receive enrollment images of an enrolled user that are obtained by the teleconferencing client application 111. Then, the personalized video enhancement module can derive a face representation of the enrolled user. Subsequently, the personalized video enhancement module can detect another object (such as a person) in a video signal, determine whether the other object matches the face of the enrolled user, and remove the other object when the other object does not match the face of the enrolled user. Alternatively, the personalized image or video enhancement model can obtain enrollment images from facial images of designated users in an image repository.

Note that FIG. 1 illustrates only one of many plausible configurations. For instance, in some cases, personalized image or video enhancement may be performed on a client device. As another example, personalized audio enhancement could be performed on a server device.

### Single Enrolled User Scenario

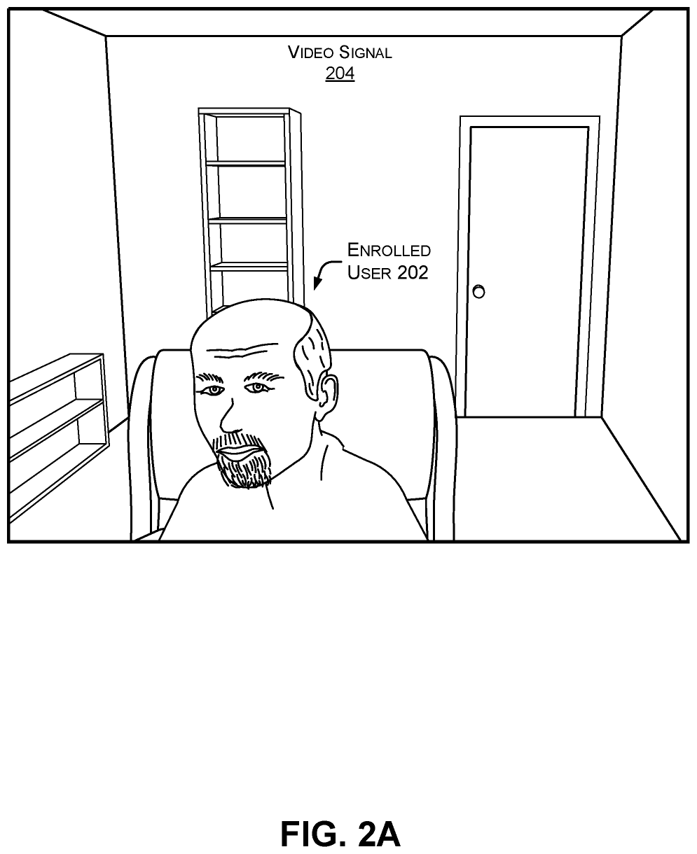

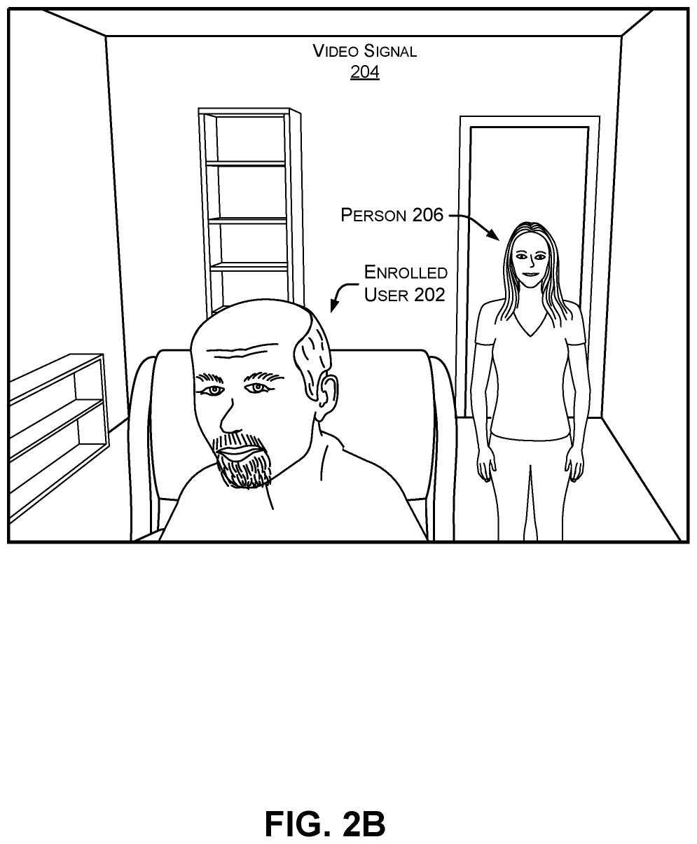

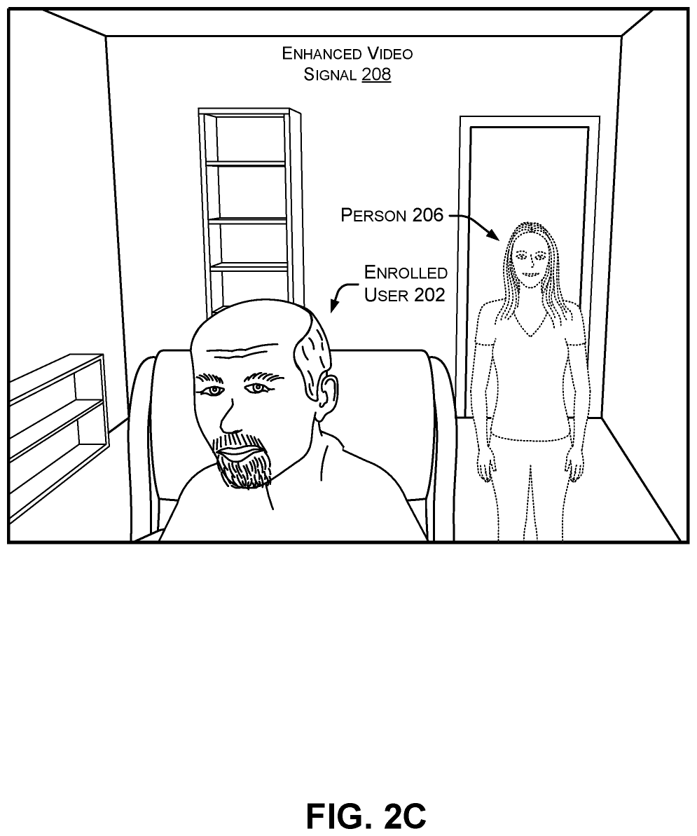

FIG. 2A-2C collectively illustrate a scenario where a single user is enrolled in personalized video enhancement. FIG. 2A shows an enrolled user 202 who appears in a video signal 204 that is transmitted to other participants in a call. For instance, enrolled user 202 may be working from their home office and participating in a teleconference with several other co-workers. The other co-workers could be located in their employer's office, at their own home offices, etc. The other co-workers can receive the video signal 204, which can be displayed on their respective devices.

FIG. 2B shows a person 206 that enters the room and appears in the video signal 204. For instance, person 206 could be a family member of enrolled user 202. The family member may not realize that the enrolled user is participating in a work-related teleconference.

FIG. 2C shows that the video feed is processed to remove person 206 to obtain enhanced video signal 208. In the enhanced video signal, person 206 is at least partially removed by blurring or completely removing the person from the enhanced video signal. The enhanced video signal can be communicated to the devices of the other co-workers. As a consequence, any disturbance or interruption caused by the presence of person 206 in the same room with the enrolled user 202 can be mitigated.

As discussed elsewhere herein, in some cases, personalized audio enhancement for enrolled user 202 can be employed together with personalized video enhancement. In these cases, the voice as well as any other noises made by person 206 will be suppressed, further reducing any disturbance or interruption by the presence of person 206.

### Multiple Enrolled Users Scenario

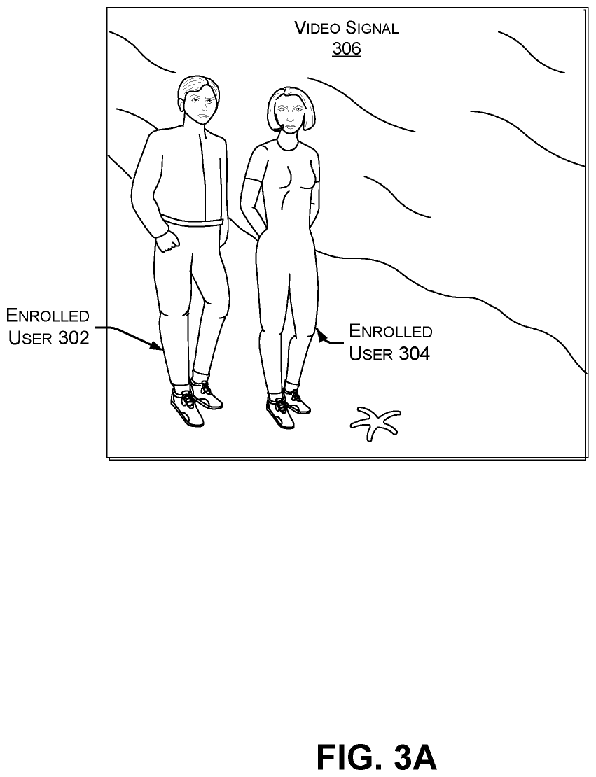

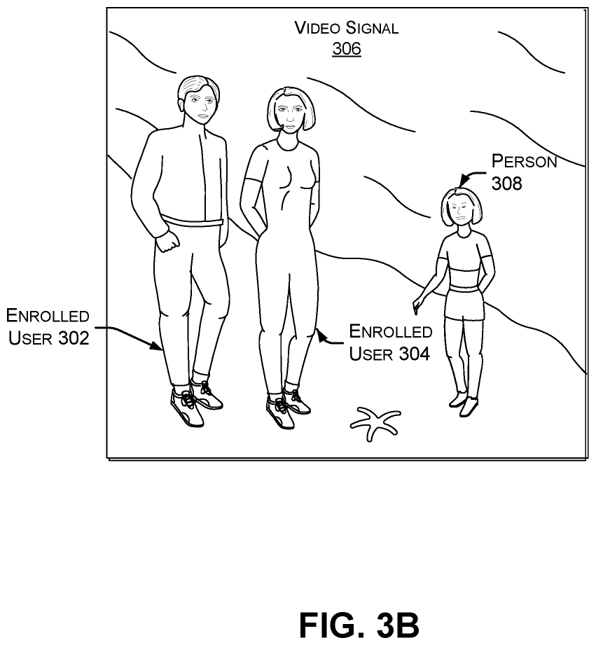

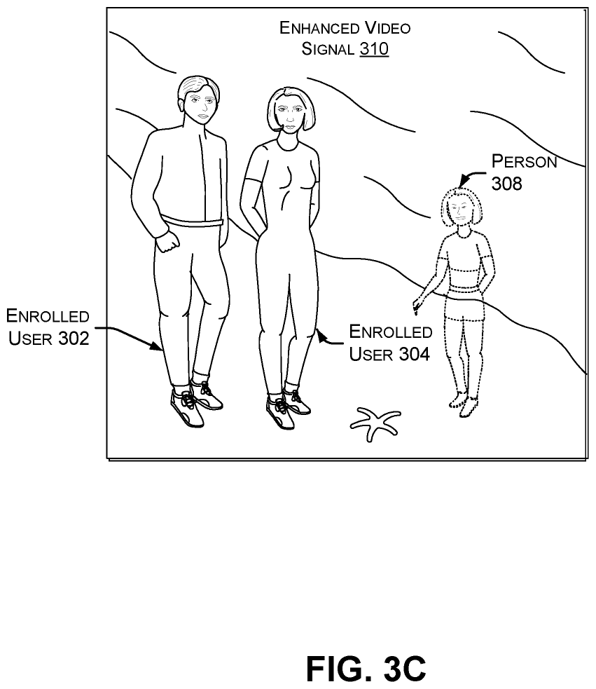

FIG. 3A-3C illustrate a scenario where multiple users are enrolled in personalized video enhancement. FIG. 3A shows enrolled users 302 and 304 who appear in a video signal 306 that is transmitted to other participants in a call. For instance, enrolled users 302 and 304 could be family members who are on vacation, and participating in a video call with one or more other family members. The other family members could be at their own homes, in a hotel nearby, etc. The other family members can receive the video signal 306, which can be displayed on their respective devices.

FIG. 3B shows a person 308 that approaches the enrolled users 302 and 304 and appears in the video signal 306. For instance, person 308 could be a child that inadvertently walks into the field of view of the video signal. The child may not realize that the enrolled users are taking a video of themselves and that the enrolled users might prefer not to have the child appear in the video.

FIG. 3C shows that the video feed is processed to remove person 308 to obtain enhanced video signal 310. In the enhanced video signal, person 308 is at least partially removed by blurring or completely removing the person from the enhanced video signal. The enhanced video signal can be communicated to the devices of the family members. As a consequence, any disturbance or interruption caused by the presence of person 308 in the vicinity of the enrolled users can be mitigated.

### Example Enrollment Scenario

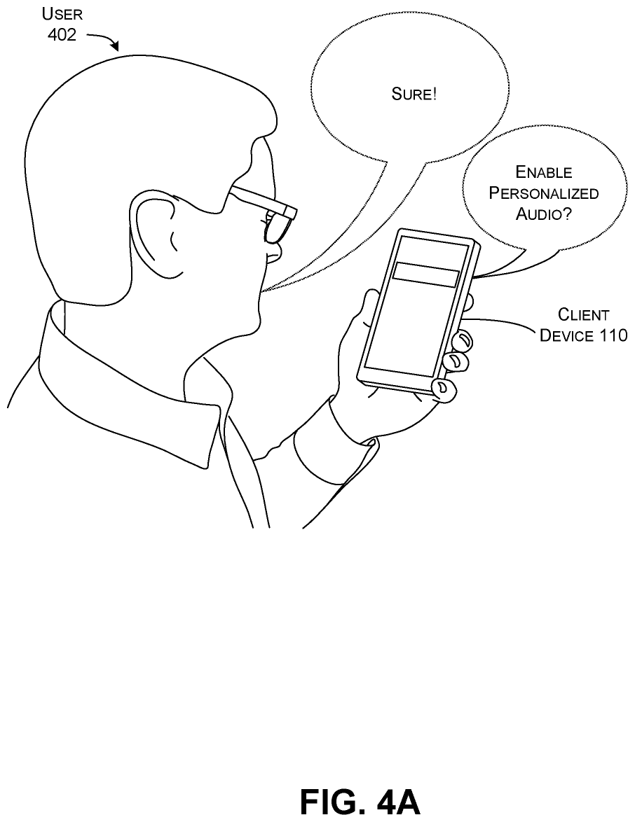

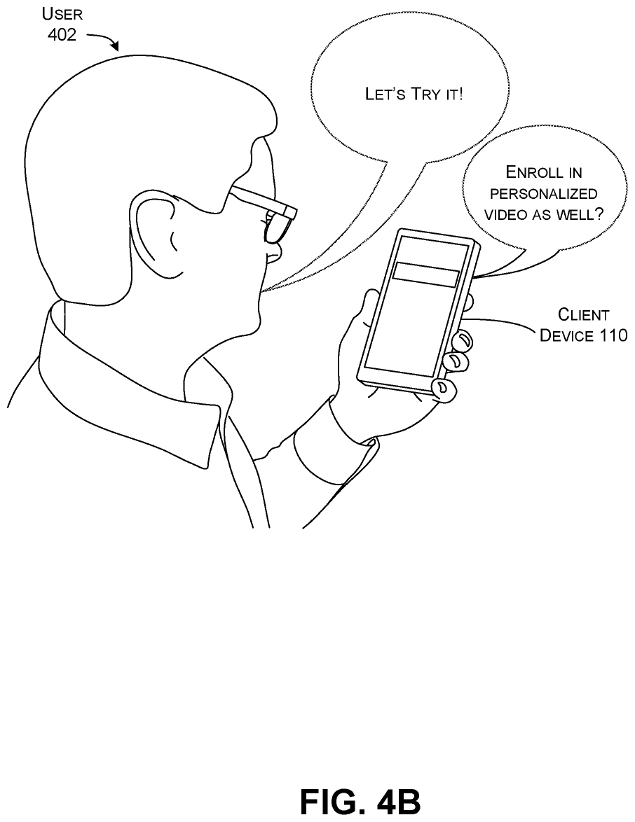

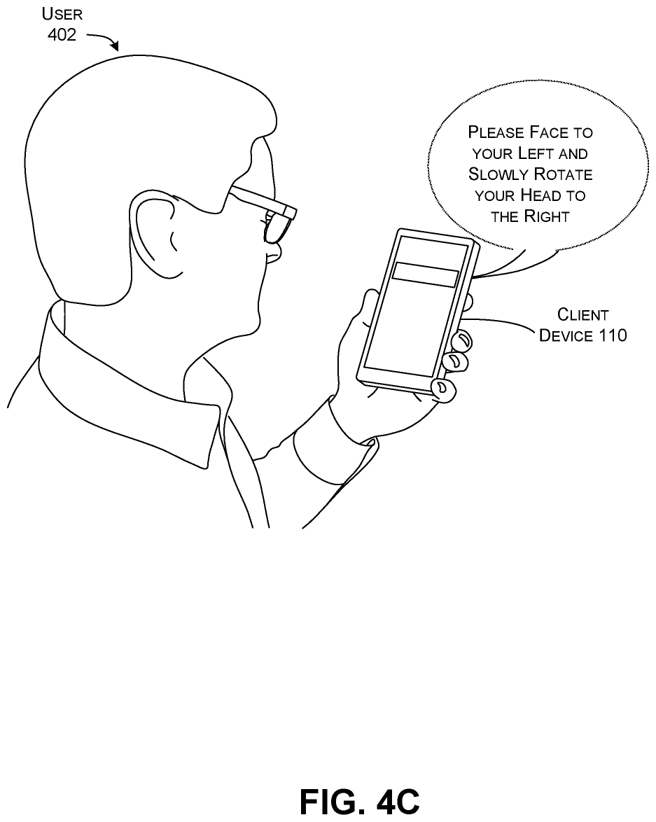

FIGS. 4A-4C illustrate a scenario where a user opts-in to personalized audio and video enhancement. In FIG. 4A, client device 110 asks user 402 whether they would like to enable personalized audio enhancement for teleconferencing. User 402 opts-in to personalized audio enhancement by verbally agreeing to try this feature.

In FIG. 4B, client device 110 asks user 402 whether they would like to enable personalized video enhancement for teleconferencing. User 402 opts-in to personalized video enhancement by verbally agreeing to try this feature. In some implementations, the teleconferencing client application 111 (FIG. 1) can prompt the user to enable personalized video enhancement based on the user's decision to enable personalized audio enhancement.

FIG. 4C shows that the client device 110 instructs user 402 to perform certain actions to enroll in personalized video enhancement. In this case, the user is instructed to rotate their face so that images of the user's face can be captured from different angles.

### Example Enrollment Processing

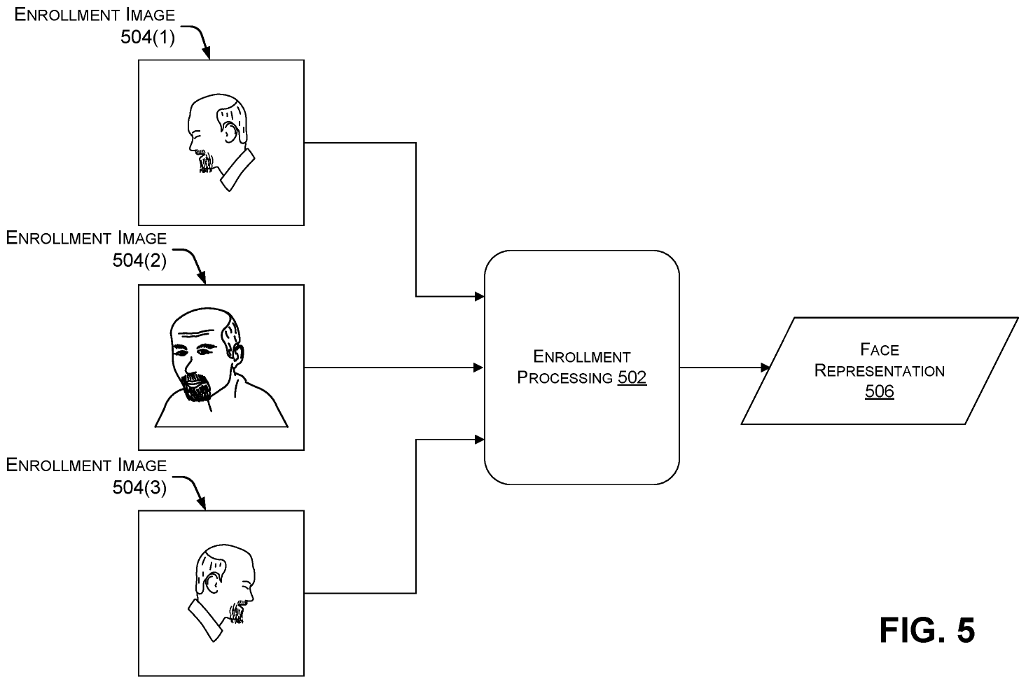

FIG. 5 illustrates an example where enrollment processing 502 is performed on enrollment images 504(1), 504(2), and 504(3) to obtain face representation 506. For instance, referring back to FIG. 4C, the enrollment images can be captured by client device 110 as user 402 rotates their face as instructed by the client device. The enrollment processing outputs a face representation 506 that can be employed to detect the user's face in a video signal.

In some cases, a machine learning approach can be employed for enrollment processing 502. For instance, a deep neural network can be employed to derive features and/or an embedding from the enrollment images that represent the user's face, e.g., Sun, et al., (2014), Deep learning face representation from predicting 10,000 classes, in Proceedings of the IEEE conference on computer vision and pattern recognition (pp. 1891-1898). As another example, the enrollment images can be processed to represent the user's face as a weighted combination of faces from a basis set of faces. Turk, et al., (1991 January), Face recognition using eigenfaces, in Proceedings 1991 IEEE computer society conference on computer vision and pattern recognition (pp. 586-587), IEEE Computer Society.

### Example Video Enhancement Workflow

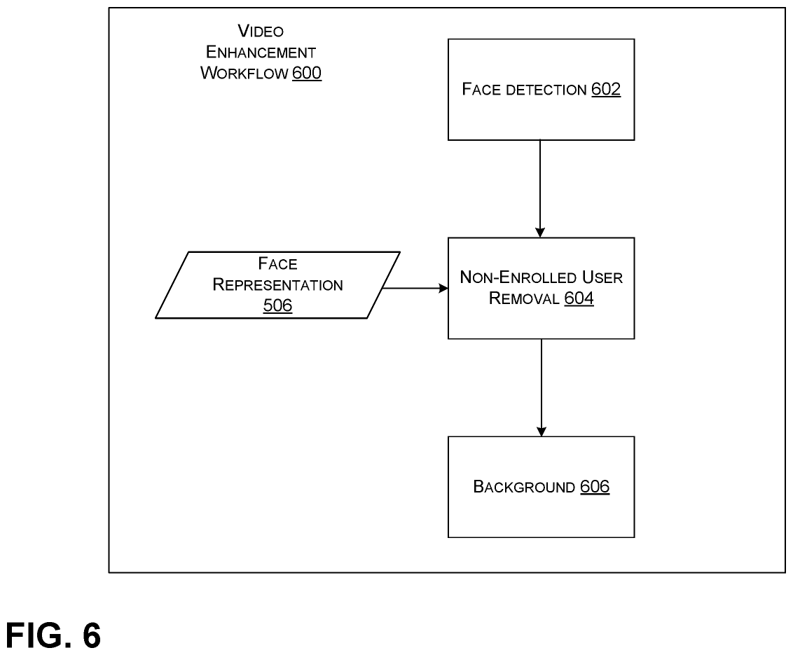

FIG. 6 illustrates an example personalized video enhancement workflow 600. Face detection 602 is performed to identify faces in a video signal. Viola, et al., (2001 December), Rapid object detection using a boosted cascade of simple features, in Proceedings of the 2001 IEEE computer society conference on computer vision and pattern recognition, CVPR 2001 (Vol. 1, pp. I-I), IEEE. For instance, a frame of the video signal can be input to a face detection model, and the face detection model can output boundaries of each face detected in that frame.

Face representation 506 is input to non-enrolled user removal 604. For each detected face that does not match the face representation, that user's face and body are removed. For instance, the face and body of non-enrolled users can be modified as background 606, e.g., by entirely removing them from the video signal, blurring them, fading them, etc. One way to remove the face and body of a given user is to employ a machine learning matting technique to identify a segmentation of the user in the video stream, where the segmentation corresponds to a boundary around the user's face and body. Cho, et al., (2016), Natural image matting using deep convolutional neural networks, in Computer Vision-ECCV 2016: 14^{th} European Conference, Amsterdam, The Netherlands, Oct. 11-14, 2016, Proceedings, Part II 14 (pp. 626-643), Springer International Publishing. Then, a portion of the video signal that occurs within the segmentation can be modified by blurring that portion of the video, modifying that portion of the video by replacing the user with pixels that match the background, etc.

### Example Image or Video Enhancement Method

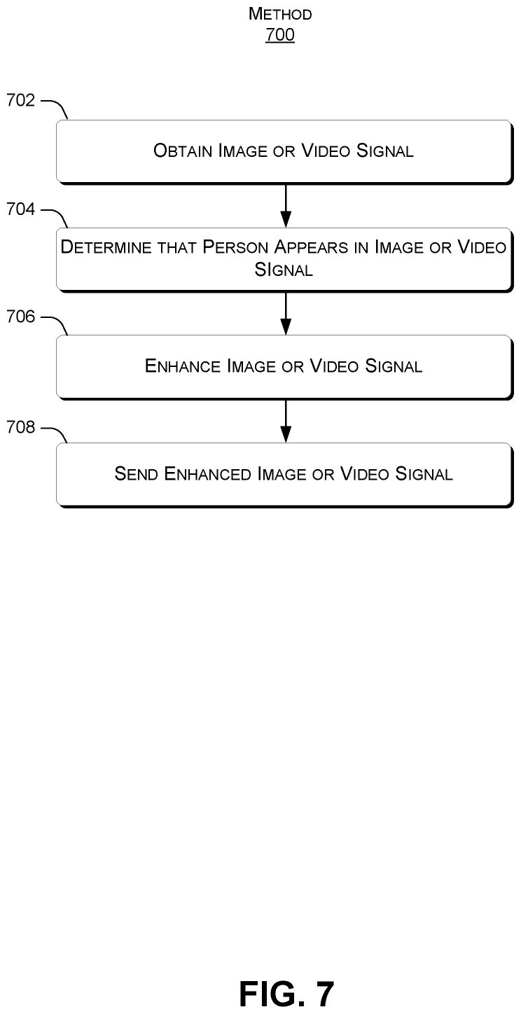

FIG. 7 illustrates an example method 700, consistent with some implementations of the present concepts. Method 700 can be implemented on many different types of devices, e.g., by one or more cloud servers, by a client device such as a laptop, tablet, or smartphone, or by combinations of one or more servers, client devices, etc.

Method 700 begins at block 702, where an image or a video signal is obtained. For instance, an image or video signal can be captured by a camera on a first device that is participating in a video call with a second device, or can be retrieved from a stored repository of still images and/or videos. The first device may have one or more designated users for personalized image or video enhancement. For instance, designated users can be users that have been explicitly or automatically enrolled in personalized video enhancement by capturing facial images from different angles to obtain face representations, or users that a repository owner has selected as designated users for the purposes of video or image enhancement.

Method 700 continues at block 704, where the method determines whether a person other than the designated user (or designated users) appears in the image or video signal. For instance, in some cases, block 704 can involve detecting faces in the image or video signal and comparing the detected faces to the face representations of the designated users. When a detected face does not match any of the designated users, then a determination is made that a person other than the designated users has appeared in the image or video signal.

Method 700 continues at block 706, where the image or video signal is enhanced. For instance, as noted above, a segmentation can be obtained around the person other than the designated users. Then, a portion of the image or video signal within that segmentation can be blurred or modified to blend into the background. In this manner, the person other than the designated users is at least partially removed from the image or video signal, resulting in an enhanced video signal. In some cases, background removal can be employed to remove users other than designated users from video signals and background interpolation to remove users other than designated users from still images. Example techniques for background interpolation include inpainting, as described at Suborov, et al., (2022), Resolution-robust Large Mask Inpainting with Fourier Convolutions, in 2022 IEEE/CVF Winter Conference on Applications of Computer Vision (WACV) (pp. 3172-3182), IEEE.

Method 700 continues at block 708, where the enhanced image or video signal is sent to another device. For teleconferencing scenarios, an enhanced video signal can be sent to a second device that is participating in the call. For instance, the second device can be located in a different room, and the enhanced video signal can be sent to the second device over a network. In some cases, the video signal can be sent to multiple remote devices, either co-located (e.g., together in a different room) or in different locations from one another. Enhanced images can be sent to a device associated with an owner of an image repository or to devices associated with user (e.g., of social media contacts of the repository owner).

In some cases, some or all of method 700 is performed by a remote server. In other cases, some or all of method 700 is performed on another device, e.g., the client device that initially captured the image or video signal. As another example, co-located devices can form a distributed peer-to-peer mesh and select a particular device to perform personalized image or video enhancement for images or video signals captured by one or more of the co-located devices.

### Teleconferencing User Experience

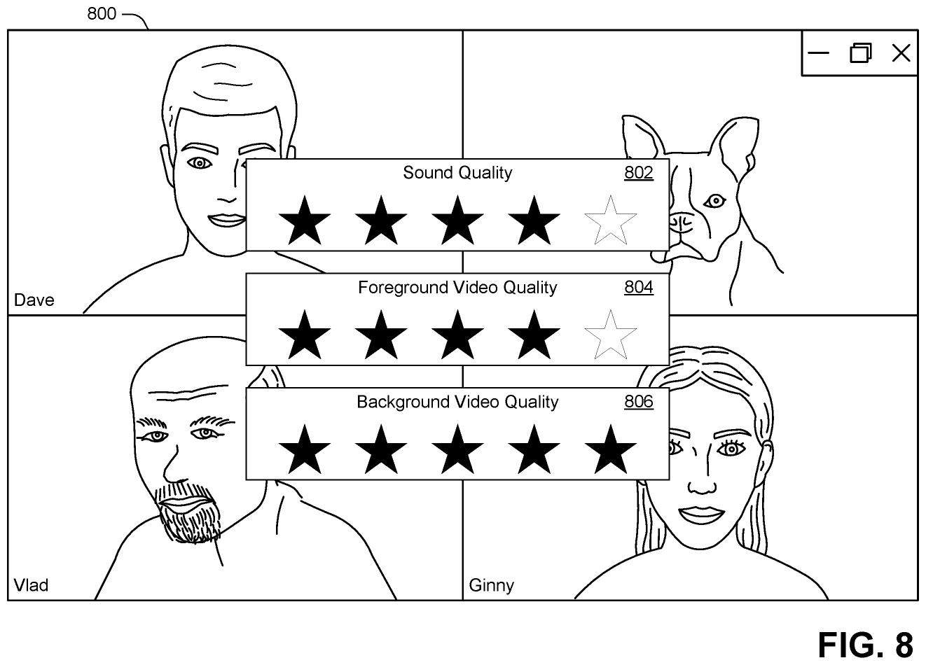

After enrolling in personalized enhancement and participating in a given call, a user may be provided with a video call GUI 800 such as that shown in FIG. 8. Video call GUI 800 includes a sound quality estimate 802 that conveys a value of four stars out of five for the audio signal of a video call, a foreground video quality estimate 804 that conveys a value of four stars for the foreground quality of the video signal of the call, and a background video quality estimate 806 that conveys a value of five stars for the background of the video signal. In some cases, the estimates are provided by automated quality estimation models.

In some cases, video call GUI 800 can include an option for the user to confirm or modify the audio or video quality ratings for each individual audio or video characteristic. The user input can be used to manually label audio or video content of the call. The labels can be used for various purposes, such as supervised training or tuning of video enhancement models.

### Additional Implementations

As noted previously with respect to FIG. 4C, one way to capture enrollment images of a user involves requesting that the user perform poses. This allows for images of the user's face to be captured from various angles. In addition, explicit enrollment can involve outputting a message indicating to the user that their personal information is being captured and retained. Thus, the user can decide to opt-out if, for privacy or other reasons, they do not wish to have their personal information stored for subsequent use.

Another way to capture enrollment images involves automatic enrollment. During the course of a user's participation in one or more calls, images of the user's face can be captured from different viewing angles, under different lighting conditions, etc. This can occur without explicitly requesting that the user perform poses to explicitly enroll in personalized video enhancement. In this case, the teleconferencing client application 111 (FIG. 1) can output a request to the user for permission to perform automatic enrollment. Thus, the user is provided with the opportunity to decline if, for privacy or other reasons, they do not wish to have images of their face or representations derived from their face stored persistently after a given video call. For still images in an image repository, the owner of the repository can select individual designated users from individual images in the repository.

In addition, there are various approaches for identifying designated users of a given device. In some cases, a device owner can log in and perform explicit enrollment to become the designated user of that device. In other cases, the teleconferencing client or server application can determine which user's face appears most frequently in the video signal captured on a given device, and then infer that user is the designated user of that device. In other cases, the teleconferencing client or server application can determine which user's voice is most frequently captured by the device, and then infer that user is the designated user of that device. For instance, the fundamental pitch of a user's voice or an embedding for personalized audio enhancement can be used to determine whether a given user is currently speaking into the device.

In other cases, however, a device owner may wish to identify other designated users of their device, e.g., other people with which they have a familial, personal, or work relationship. For instance, referring back to FIG. 3A, assume that enrolled user 304 is the device owner. The enrolled user may wish to add their family members (e.g., enrolled user 302) to a list of designated users so that their family members are not removed by personalized video enhancement. For instance, enrolled user 304 could explicitly provide input to their device identifying their family members as designated users of the device. Subsequently, those family members could be explicitly or automatically enrolled for future personalized video enhancement, where multiple designated users are retained in a given enhanced video signal.

In other cases, additional designated users for a given device can be inferred from other data. For instance, the teleconferencing client or server application could access a photo repository of the device owner and identify faces that occur frequently within the repository. Those other users could be automatically added as designated users of the device. For instance, the teleconferencing client or server application could output a suggestion to the device owner to add, as additional designated users, other people that occur in more than a threshold percentage (e.g., 10%) of the device owner's photographs.

In further implementations, personalized video enhancement can be enabled based on a user's decision to enable personalized audio enhancement. For example, if a user is already enrolled for personalized video enhancement, then personalized video enhancement can be enabled in response to a request from the user to enable personalized audio enhancement. If the user is not already enrolled for personalized video enhancement, then automatic or explicit enrollment can be initiated in response to a request from the user to enable personalized audio enhancement.

Referring back to FIG. 8, users can be provided the opportunity to give feedback on video quality. If video quality starts to suffer, this could be as a result of the user's appearance changing and deviating from the images that were captured when they enrolled. At that time, additional enrollment images can be captured for that user. This can be helpful for situations where the user's face may change due to weight loss or gain, facial hair changes, etc. In addition, this could also be helpful where the user's appearance does not change but the conditions under which the video is captured change. For instance, the following circumstances could cause degradation in the quality of personalized video enhancement such that capturing new enrollment issues could improve enhancement quality: the user changes the room where they typically conduct teleconferences and the new room has different lighting conditions, the user gets a new web camera or repositions their existing web camera, the user adds or removes lighting from the room where they conduct teleconferences, etc.

### Technical Effect

As noted previously, prior techniques for enhancing signals for teleconferencing tend to perform well at removing impairments such as noise or echoes from an audio signal or correcting low-lighting conditions in a video signal. Further, personalized audio enhancement models can help a great deal at improving overall audio as well as speech quality, by suppressing sounds other than the voice of an enrolled user.

However, as noted above, using personalized audio enhancement alone can tend to create some confusing or distracting experiences. For instance, if a non-enrolled user enters the room with a person conducting a call and starts talking, other call participants will see the person's mouth move but not be able to hear their voice. By employing personalized video enhancement together with personalized audio enhancement, the person can also be removed from the video signal. Thus, other users may not even be aware that the other person has even entered the room.

In addition, the use of personalized video enhancement can have positive implications for privacy. For instance, some people would prefer that they are not recorded in public, e.g., by images or video. Personalized video enhancement allows a device owner to easily configure their device so that only certain designated users are recorded by the device. Thus, not only does the device owner get the benefit of not having to see other people in their video signals, but the other people get the benefit of not being recorded in public. Similarly, owners of image repositories can have non-designated users automatically removed from images in their repositories, thus respecting the privacy of others while removing unwanted users from their images.

Furthermore, some implementations involve automatically identifying designated users of a device. For instance, a device owner or primary user can be identified based on the frequency with which that user speaks into the device or appears in video captured by the device. This, in turn, alleviates the burden on the device owner to provide input explicitly designating themselves as a designated user. Likewise, by processing a photo repository of a device owner to automatically identify other designated users, the device owner can be relieved of the burden of providing input specifically designating other individuals as additional designated users of the device.

### Device Implementations

As noted above with respect to FIG. 1, system 100 includes several devices, including a client device 110, a client device 120, a client device 130, and a server 140. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 150. Without limitation, network(s) 150 can include one or more local area networks (LANs), wide area networks (WANs), the Internet, and the like.

### Additional Examples

Various examples are described above. Additional examples are described below. One example includes a method comprising obtaining a video signal captured by a first device participating in a video call with a second device, the first device having a designated user, determining that a person other than the designated user appears in the video signal, enhancing the video signal by at least partially removing the person other than the designated user from the video signal to obtain an enhanced video signal, and sending the enhanced video signal to the second device.

Another example can include any of the above and/or below examples where the determining comprises detecting the face of the person other than the designated user in the video signal and determining that the detected face does not match the face of the designated user.

Another example can include any of the above and/or below examples where the removing comprises blurring or replacing at least the face of the person other than the designated user.

Another example can include any of the above and/or below examples where the method further comprises performing explicit facial enrollment of the designated user by instructing the designated user to perform one or more poses and capturing one or more enrollment images of the designated user while the one or more poses are performed.

Another example can include any of the above and/or below examples where the method further comprises performing automatic enrollment of the designated user by capturing one or more enrollment images of the designated user while the designated user participates in the video call.

Another example can include any of the above and/or below examples where the method further comprises receiving user input indicating permission from the designated user prior to performing to the automatic enrollment.

Another example can include any of the above and/or below examples where the method further comprises identifying the designated user based at least on how frequently the designated user's voice is captured by the first device.

Another example can include any of the above and/or below examples where the method further comprises identifying the designated user based at least on how frequently the face of the designated user is captured by the first device.

Another example can include any of the above and/or below examples where the method further comprises identifying another designated user of the first device in the video signal, where the enhancing retains both the designated user and the another designated user in the enhanced video signal.

Another example can include any of the above and/or below examples where the method further comprises identifying the another designated user based at least on a relationship of the designated user to the another designated user.

Another example can include any of the above and/or below examples where the method further comprises detecting the relationship based at least on input received from the designated user or occurrence of the another designated user in a photo repository of the designated user.

Another example can include any of the above and/or below examples where the method further comprises performing explicit or automatic enrollment of both the designated user and the another designated user of the first device.

Another example can include any of the above and/or below examples where the method further comprises enabling the enhancing responsive to determining that the designated user enabled personalized audio enhancement for the video call.

Another example includes a system comprising a processor and a storage medium storing instructions which, when executed by the processor, cause the system to obtain a video signal captured by a first device participating in a video call with a second device, the first device having a designated user, detect that a person other than the designated user appears in the video signal, enhance the video signal to obtain an enhanced video signal by at least partially removing the person other than the designated user from the video signal, and send the enhanced video signal to the second device.

Another example can include any of the above and/or below examples where a face of the person other than the designated user is detected in the video signal.

Another example can include any of the above and/or below examples where the instructions, when executed by the processor, cause the system to provide a frame of the video signal to a machine learning model trained to detect faces and receive an indication from the machine learning model that the face is detected.

Another example can include any of the above and/or below examples where the instructions, when executed by the processor, cause the system to obtain a face representation of the designated user, the face representation comprising one or more features or embeddings provided by a machine learning model or a weighted combination of faces from a basis set of faces, based on the face representation, determine that the face of the person does not match the face of the designated user and remove the person responsive to determining that the face of the person does not match the face of the designated user.

Another example can include any of the above and/or below examples where the instructions, when executed by the processor, cause the system to receive, from a machine learning model, a segmentation of the another person and enhance the video signal by modifying a portion of the video signal that occurs within the segmentation.

Another example can include any of the above and/or below examples where the system is embodied on the first device, another device co-located with the first device that is also participating in the video call, or a server located remotely from the first device.

Another example includes a computer-readable storage medium storing executable instructions which, when executed by a processor, cause the processor to perform acts comprising obtaining an image captured by a first device, the image being associated with a designated user, responsive to person other than the designated user appearing in the image, enhancing the image to obtain an enhanced image by at least partially removing the person other than the designated user, and sending the enhanced image to the first device, a second device, or storing the enhanced image in an image repository.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
obtaining a video signal captured by a first device participating in a video call with a second device, the first device having a designated user;
determining that a person other than the designated user appears in the video signal;
enhancing the video signal by at least partially removing the person other than the designated user from the video signal to obtain an enhanced video signal; and
sending the enhanced video signal to the second device.

2. The method of claim 1, wherein the determining comprises:
detecting the face of the person other than the designated user in the video signal; and
determining that the detected face does not match the face of the designated user.

3. The method of claim 1, wherein the removing comprises blurring or replacing at least the face of the person other than the designated user.

4. The method of claim 1, further comprising:
performing explicit facial enrollment of the designated user by:
instructing the designated user to perform one or more poses; and
capturing one or more enrollment images of the designated user while the one or more poses are performed.

5. The method of claim 1, further comprising:
performing automatic enrollment of the designated user by capturing one or more enrollment images of the designated user while the designated user participates in the video call.

6. The method of claim 5, further comprising receiving user input indicating permission from the designated user prior to performing to the automatic enrollment.

7. The method of claim 1, further comprising identifying the designated user based at least on how frequently the designated user's voice is captured by the first device.

8. The method of claim 1, further comprising identifying the designated user based at least on how frequently the face of the designated user is captured by the first device.

9. The method of claim 1, further comprising:
identifying another designated user of the first device in the video signal,
wherein the enhancing retains both the designated user and the another designated user in the enhanced video signal.

10. The method of claim 9, further comprising:
identifying the another designated user based at least on a relationship of the designated user to the another designated user.

11. The method of claim 10, further comprising:
detecting the relationship based at least on input received from the designated user or occurrence of the another designated user in a photo repository of the designated user.

12. The method of claim 11, further comprising performing explicit or automatic enrollment of both the designated user and the another designated user of the first device.

13. The method of claim 1, further comprising:
enabling the enhancing responsive to determining that the designated user enabled personalized audio enhancement for the video call.

14. A system comprising:
a processor; and
a storage medium storing instructions which, when executed by the processor, cause the system to:
obtain a video signal captured by a first device participating in a video call with a second device, the first device having a designated user;
detect that a person other than the designated user appears in the video signal;
enhance the video signal to obtain an enhanced video signal by at least partially removing the person other than the designated user from the video signal; and
send the enhanced video signal to the second device.

15. The system of claim 14, wherein a face of the person other than the designated user is detected in the video signal.

16. The system of claim 15, wherein the instructions, when executed by the processor, cause the system to:
provide a frame of the video signal to a machine learning model trained to detect faces; and
receive an indication from the machine learning model that the face is detected.

17. The system of claim 15, wherein the instructions, when executed by the processor, cause the system to:
obtain a face representation of the designated user, the face representation comprising:
one or more features or embeddings provided by a machine learning model, or
a weighted combination of faces from a basis set of faces;
based on the face representation, determine that the face of the person does not match the face of the designated user; and
remove the person responsive to determining that the face of the person does not match the face of the designated user.

18. The system of claim 15, wherein the instructions, when executed by the processor, cause the system to:
receive, from a machine learning model, a segmentation of the another person; and
enhance the video signal by modifying a portion of the video signal that occurs within the segmentation.

19. The system of claim 15, embodied on the first device, another device co-located with the first device that is also participating in the video call, or a server located remotely from the first device.

20. A computer-readable storage medium storing executable instructions which, when executed by a processor, cause the processor to perform acts comprising:
obtaining an image captured by a first device, the image being associated with a designated user;
responsive to person other than the designated user appearing in the image, enhancing the image to obtain an enhanced image by at least partially removing the person other than the designated user; and
sending the enhanced image to the first device, a second device, or storing the enhanced image in an image repository.
